(19) United States
(12) Patent Application Publication
(10) Pub. No.: US 2007/0253718 A1
(43) Pub. Date: Nov. 1, 2007

(54) Optical Add/Drop Amplification Device

(76) Inventors: Roberto Magri, Parma (IT); Matteo Costantini, Genova (IT)

Correspondence Address: COATS & BENNETT, PLLC, 1400 Crescent Green, Suite 300, Cary, NC, 27518, US

(21) Appl. No.: 10/598,574

(22) PCT Filed: Mar. 3, 2005
(86) PCT No.: PCT/EP05/50955

§ 371 Date: Mar. 19, 2007

(30) Foreign Application Priority Data
Mar. 5, 2004 (IT) MI2004A000431

(51) Int. Cl. H04B 10/16

(52) U.S. Cl. 398/175

(57) ABSTRACT

In an optical add/drop amplification device (1) arranged between fibre spans (2, 3) in an optical telecommunications system, comprising a first input amplifier (4), a channel add/drop device (7) and an output amplifier (8) connected in a series path, the input amplifier (4) is arranged to produce substantially constant output power, such that the output power of amplified spontaneous emission (ASE) noise compensates in use for loss of signal power in the event of breakage of a fibre span, to ensure survival of any channels added at the add/drop device. In accordance with the invention, an additional input amplifier (9) is provided to produce the compensating ASE noise in the event of failure of the first input amplifier.

This invention relates to a optical add/drop amplification devices for use in wavelength division multiplex (WDM) optical fibre telecommunications system, and to a method of ensuring survival of optical channels added at such an optical add/drop amplification device.

As is known optical add/drop amplification devices (nodes) are sited at the interconnection of fibre spans within WDM optical telecommunications system and enable optical channels to be added to or dropped from the optical fibre span, and amplify the on-going WDM optical channels (through channels) to restore their power for transmission along the next span. Optical channels are added/dropped with the device using an optical add/drop multiplexer (OADM) device.

Typically, such amplication devices include an output (or booster) optical amplifier arranged in a constant power mode, that is there is no change in output power regardless of any input power change. A constant power mode can be achieved by monitoring the output power of the optical amplifier, for example with a photodiode and using a feedback loop such that output power fluctuations are used as an error signal for an optical pump of the optical amplifier.

In the event of a break in the fibre span leading to the interconnection (that is upstream of the device), this can cause a problem if measures are not taken, since the only channels reaching the output amplifier will be the optical channels added at the device, and these would be amplified excessively in an attempt to maintain constant output power. In turn this would overload optical amplifiers at subsequent interconnections (i.e. traffic card receivers) downstream of the device and cause non-linear distortion during propagation due to high transmitted power.

An example of one measure taken to avoid this problem is disclosed in International patent application, publication number WO02080409, in which the add/drop amplification device includes an input optical amplifier (or pre-amplifier) that is also operated in a constant power mode. The input amplifier which is located before the OADM device, amplifies Amplified Spontaneous Emission (ASE) noise to compensate for the power of the channels lost due to the fibre span breakage, so that the input presented to the output amplifier is constant power.

However, this compensation is ineffective in the event that the input amplifier itself fails. The present invention has arisen in an endeavour to at least in part overcome the limitations of the known optical amplification devices.

According to the present invention there is provided an optical add/drop amplification device for arrangement between fibre spans in an optical telecommunications system, which comprises: a first input amplifier; a channel add/drop device coupled to the first input amplifier; an output amplifier coupled to the channel add/drop device, wherein the input amplifier is arranged to produce substantially constant output power, such that the output power of amplified spontaneous emission (ASE) noise compensates in use for loss of signal power in the event of breakage of a fibre span, to ensure survival of any channels added at the add/drop device, the device being characterised by an additional input amplifier which is arranged to provide the compensating amplified spontaneous emission noise in the event of failure of the first input amplifier. The invention ensures the survival of added channels even in the event of breakage of the fibre span and/or a failure of the first input amplifier.

Advantageously the additional input amplifier is connected to the first input amplifier, and is arranged to operate in response to failure of the first input amplifier. Preferably the additional input amplifier is arranged to switch on when it fails to detect any optical power from the first input amplifier. When the first input amplifier includes a monitor output a photodiode of the additional input amplifier is advantageously arranged to sense light from the monitor output of the first input amplifier.

Advantageously the output power of the additional input amplifier is set so that when it is switched on, it will give the same output power as that previously produced by the first input amplifier and arranged to produce a substantially constant output power.

According to a second aspect of the invention there is provided a method of ensuring survival of channels added at an optical add/drop amplification device arranged between fibre spans in an optical telecommunications system, in which amplified spontaneous emission (ASE) noise produced in an input amplifier of the amplification device is used to compensate for loss of signal power in the event of breakage of a fibre span, to ensure survival of any channels added at the add/drop device, and characterised by producing the compensating noise in an additional input amplifier in the event of failure of the input amplifier. The method of the invention ensures the survival of added channels even in the event of breakage of the fibre span and/or a failure of the input amplifier.

Advantageously the method further comprises the additional input amplifier sensing light from the monitor output of the input amplifier.

An optical add/drop amplification device constructed in accordance with the invention will now be described in detail, by way of example only, with reference to the accompanying drawings, in which:

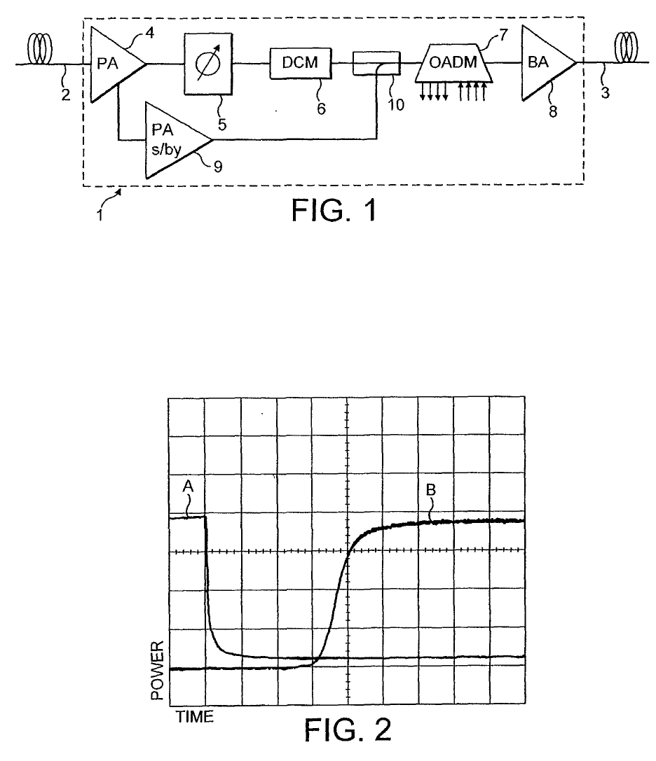

FIG. 1 is a block diagram of the device;

FIG. 2 shows graphs of the output of a first input amplifier and an additional input amplifier;

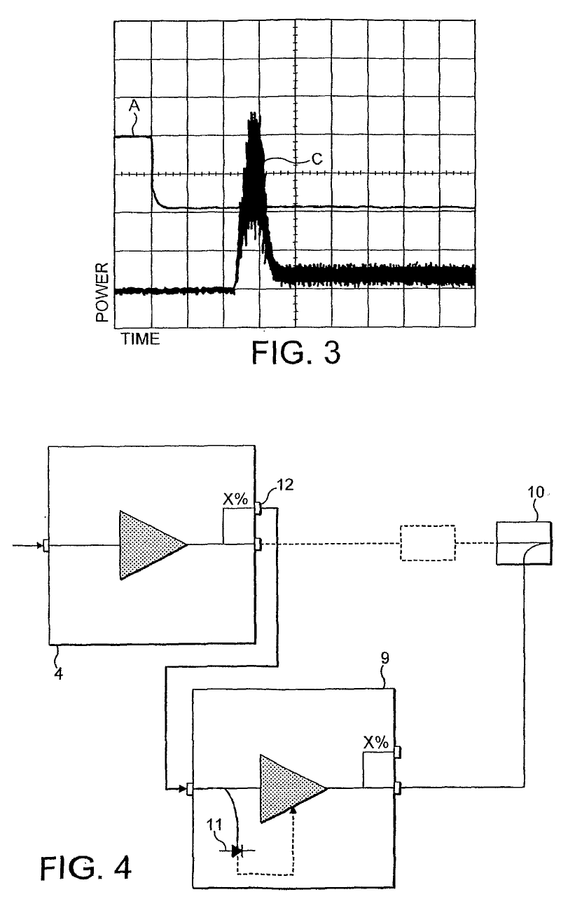

FIG. 3 shows a graph of a surviving added channel; and

FIG. 4 is a block diagram showing part of the device shown in FIG. 1 in greater detail.

Referring to FIG. 1 there is shown an optical add/drop amplification device (or optical add/drop node) indicated by the reference numeral 1 and shown within a dashed line box for interconnecting two optical fibre spans 2, 3 in a WDM optical fibre communications network. The communications network can for example comprise a ring network in which the nodes 1 are connected serially to form a closed ring or as part of another network architecture. The device 1 comprises, serially connected between an input and output of the device, an input optical amplifier (or pre-amplifier) 4, an optical attenuator 5 (which is optional and can be fixed or variable attenuation), a dispersion compensating module (DCM) 6 (which is used to compensate chromatic dispersion accumulated along the transmission fibre, and which is also optional), an optical add/drop multiplexer (OADM) device 7 and an output (or booster) optical amplifier 8. The input and output optical amplifiers comprise for example an erbium doped fibre amplifier (EDFA) and each is operated in a constant power mode using an feedback loop to control the amplifier pump power (the control loop is not illustrated in the figures as this is readily by those skilled in the art). The device described thus far is functionally the same as the system described in our earlier International Patent Application WO02080409.

In one example given in that International patent publication, the signal entering the add/drop amplification device 1 consists of forty channels, some of which are dropped at OADM 7, while a single channel is added there. In the event of breakage of fibre span 2, a feedback mechanism replaces the lost power of the thirty-nine channels with ASE noise generated by the input optical amplifier 4, to maintain constant output power at the output of OADM 7. Thus the power of the added channel at the output of the output amplifier 8 remains the same after breakage as before, and the output amplifier 8 keeps on working at its nominal working point. It can be assumed that no power variation appears at the output of the output amplifier 8 since the ASE power is equivalent to the power of lost through channels.

The traffic-survivability solution described in the International Patent Application referred to will not however work in the event of failure of the input amplifier 4 itself. In such a case, in fact, no ASE noise would be output by this amplifier and the compensating effect is lost.

In accordance with the invention, an additional (or standby) input optical amplifier (or pre-amplifier) 9 is provided which protects the first (working) input amplifier 4 in the event of failure of the amplifier 4. The output of the standby input amplifier is coupled to the main optical path of the device upstream of the OADM 7 by an optical coupler 10. As shown the coupler is preferable located between the output of the DCM 6 and the input of the OADM 7. The coupler splitting-ratio is selected to take account of the different losses in the two branches.

The standby input amplifier 9 is configured to switch on automatically if the first input amplifier 4 fails. All the time the first input amplifier is operational the standby amplifier remains switched off. Automatic switching on of the standby input amplifier is conveniently achieved by connecting a monitor output port 12 of the first input amplifier 4 to the input of the standby input amplifier 9 with an optical patchcord.

If in operation the first (main) input amplifier 4 fails, the standby input amplifier 9, which is switched off and monitors the output of the main input amplifier 4 using a monitor photodiode 11, starts and provides ASE noise at the input to the output amplifier 8 to guarantee survival of channels added at the OADM filter 7. Referring to FIG. 4 the main input amplifier 4 has a monitor output 12 that outputs a small portion x % of the output optical power of the amplifier. This is connected to the input of the stand-by amplifier 9, which detects this output power using photodiode 11 and uses this output power as a switch. When the standby amplifier 9 no longer detects any optical input power, or the optical power falls below a predetermined threshold, the standby amplifier is switched on. This mode of optical power control both guarantees quick response and works with faults that affect the electronics of the input amplifier and prevent communication between the two. Since the standby input amplifier 9 needs only to output ASE noise, its design is much simplified compared to the main input amplifier 4 and its electronics is also simplified to allow a very fast switching-on and reduced cost. The standby input amplifier 9 works with an output power control loop in a constant power mode (the control loop is not shown in FIG. 4 and is readily derivable by those skilled in the art). Its output power is set at the same value as the main input amplifier 4, so when it is switched on it will give the same output power as that previously given by the main input amplifier 4.

FIG. 2 shows (A) and (B) the output powers of the first input amplifier 4 and the standby input amplifier 9, respectively, and illustrates the failure (A) of the main input amplifier 4 and the consequent fast switching on (B) of the standby input amplifier 9. FIG. 3 shows (C) the surviving channel received power in comparison with (A) the output power of the main input amplifier 4. As it can be seen, the power variation occurs only during the fast transient, after this time the received power is restored to its operating value. Due to the fast switching (<1 ms), the risk of damage to the transponders is avoided and the traffic is restored before any critical situation can arise.

1-7. (canceled)

8. An optical add/drop amplification node configured to communicatively interconnect first and second optical fiber spans in an optical telecommunications system, the node comprising:
a channel add/drop device;
an output amplifier coupled to an output of the channel add/drop device;
a first input amplifier communicatively coupled between the first optical fiber span and an input of the channel add/drop device, and configured to output optical signals at a substantially constant output power, such that an output power of amplified spontaneous emission (ASE) noise produced by the first input amplifier compensates for a loss of signal power due to a break in the first optical fiber span; and
a second input amplifier configured to generate the compensating ASE noise responsive to a failure of the first input amplifier.

9. The optical add/drop amplification node of claim 8 wherein the second input amplifier is coupled to the first input amplifier, and is configured to generate the compensating ASE noise responsive to detecting the failure of the first input amplifier.

10. The optical add/drop amplification node of claim 9 wherein the second input amplifier is coupled to switch on responsive to detecting the failure of the first input amplifier.

11. The optical add/drop amplification node of claim 10 wherein the second input amplifier comprises a photodiode configured to sense light output by a monitor output of the first input amplifier.

12. The optical add/drop amplification node of claim 10 wherein the second input amplifier is configured to generate the compensating ASE noise at substantially the same constant output power as the first input amplifier prior to the failure of the first input amplifier.

13. The optical add/drop amplification node of claim 8 wherein the channel add/drop device comprises an Optical Add/Drop Multiplexer (OADM) device.

14. A method of maintaining channels added at an optical add/drop amplification node disposed between first and second optical fiber spans in an optical telecommunications system, the method comprising:
outputting amplified spontaneous emission (ASE) noise from a first input amplifier, such that an output power of the ASE noise compensates for a loss of signal power due to a break in the first optical fiber span; and
generating the ASE noise at a second input amplifier communicatively coupled to the first input amplifier responsive to detecting a failure of the first input amplifier.

15. The method claim 14 further comprising monitoring the first input amplifier at the second input amplifier.

16. The method of claim 15 wherein monitoring the first input amplifier at the second input amplifier comprises sensing light output by a monitor output of the first input amplifier.

17. The method of claim 16 further comprising detecting that the first input amplifier has failed responsive to failing to sense the light output by the monitor output.

18. The method of claim 16 further comprising switching the second input amplifier on to generate the ASE noise responsive to detecting that the first input amplifier has failed.

19. The method of claim 14 wherein generating the ASE noise at a second input amplifier comprises outputting the ASE noise at substantially the same constant output power as the first input amplifier prior to the failure of the first input amplifier.
